(19) United States
(12) Patent Application Publication
(10) Pub. No.: US 2024/0291135 A1
(43) Pub. Date: Aug. 29, 2024

(54) ANTENNA DEVICE AND IC CARD HAVING THE SAME

(71) Applicant: TDK Corporation, Tokyo (JP)

(72) Inventor: Shoma KAJIKIYA, Tokyo (JP)

(21) Appl. No.: 18/587,758

(22) Filed: Feb. 26, 2024

(30) Foreign Application Priority Data
Feb. 28, 2023 (JP) 2023-029744

(51) Int. Cl. H01Q 1/22; H01Q 7/00

(52) U.S. Cl. CPC H01Q 1/2283; H01Q 7/00

(57) ABSTRACT

Disclosed herein is an antenna device that includes a magnetic body having a through hole therein, and a coil pattern having upper and bottom surfaces positioned opposite to each other in a thickness direction thereof and a side surface connecting the upper and bottom surfaces. The coil pattern is partially embedded in the magnetic body such that the upper and side surfaces of the coil pattern are at least partially covered with the magnetic body. The coil pattern includes a first winding part and a second winding part protruding from the first winding part toward the through hole formed in the magnetic body in a plan view and wound in a direction opposite to the winding direction of the first winding part. The second winding part is wound along a periphery of the through hole formed in the magnetic body.

### CROSS-REFERENCE TO RELATED APPLICATION

This application claims the benefit of Japanese Patent Application No. 2023-029744, filed on Feb. 28, 2023, the entire disclosure of which is incorporated by reference herein.

### BACKGROUND

The present disclosure relates to an antenna device and an IC card having the same.

JP 2015-220719A discloses an antenna device having a structure in which a coil pattern is embedded in the surface of a magnetic body. The antenna device disclosed in JP 2015-220719A can communicate with devices positioned on the side at which the coil pattern is embedded, but has a difficulty in communicating with devices positioned on the side opposite to the side at which the coil pattern is embedded.

### SUMMARY

An antenna device according to one embodiment of the present disclosure includes a magnetic body having a through hole therein, and a coil pattern having upper and bottom surfaces positioned opposite to each other in a thickness direction thereof and a side surface connecting the upper and bottom surfaces. The coil pattern is partially embedded in the magnetic body such that the upper and side surfaces of the coil pattern are at least partially covered with the magnetic body. The coil pattern includes a first winding part and a second winding part protruding from the first winding part toward the through hole formed in the magnetic body in a plan view and wound in a direction opposite to the winding direction of the first winding part. The second winding part is wound along a periphery of the through hole formed in the magnetic body.

### BRIEF DESCRIPTION OF THE DRAWINGS

The above features and advantages of the present disclosure will be more apparent from the following description of certain embodiments taken in conjunction with the accompanying drawings, in which:

FIG. 1 is a schematic perspective view illustrating the outer appearance of an IC card 3 according to one embodiment of the present disclosure having an antenna device;

FIG. 2 is a schematic exploded perspective view for explaining the structure of the IC card 3 having an antenna device 1 according to a first embodiment of the present disclosure;

FIG. 3 is a schematic cross-sectional view for explaining the structure of the IC card 3 having an antenna device 1 according to the first embodiment of the present disclosure;

FIG. 4 is a schematic plan view of the conductor patterns including the coil pattern CP;

FIG. 5A is a schematic view for explaining the sectional shape of the coil pattern CP embedded in the magnetic body 30;

FIG. 5B is a schematic view for explaining the sectional shape of the insulating film 141 according to a modification;

FIG. 6 is a schematic perspective view of the IC module 50 as viewed from the back surface side thereof;

FIG. 7 is a schematic diagram showing a state in which the IC card 3 and the card reader 6 communicate;

FIG. 8 is a schematic plan view for explaining the pattern shape of the second winding part 120 according to a modification;

FIG. 9 is a schematic plan view for explaining a method of forming the second winding part 120 according to the modification;

FIG. 10 is a schematic plan view for explaining the pattern shape of the coil pattern CP according to a modification; and

FIG. 11 is a schematic cross-sectional view for explaining the structure of an IC card 3A having an antenna device 1A according to a modification of the present embodiment.

### DETAILED DESCRIPTION OF THE EMBODIMENTS

An object of the present disclosure is to enable communication with devices on both sides of a magnetic body in an antenna device having a structure in which at least a part of a coil pattern is embedded in the magnetic body.

Some embodiments of the present disclosure will be explained below in detail with reference to the accompanying drawings.

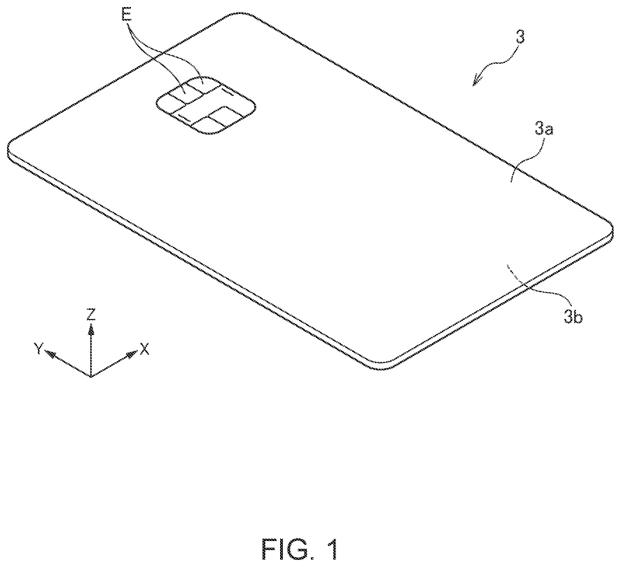

FIG. 1 is a schematic perspective view illustrating the outer appearance of an IC card 3 according to one embodiment of the present disclosure having an antenna device.

As illustrated in FIG. 1, the IC card 3 according to the present embodiment has a plate-like shape in which the Y-, X-, and Z-directions are defined as the longer length direction, shorter length direction, and thickness direction, respectively, and has an upper surface 3a and a back surface 3b which constitute the XY plane. The IC card 3 incorporates therein an IC module to be described later whose terminal electrode E is exposed to the upper surface 3a of the IC card 3.

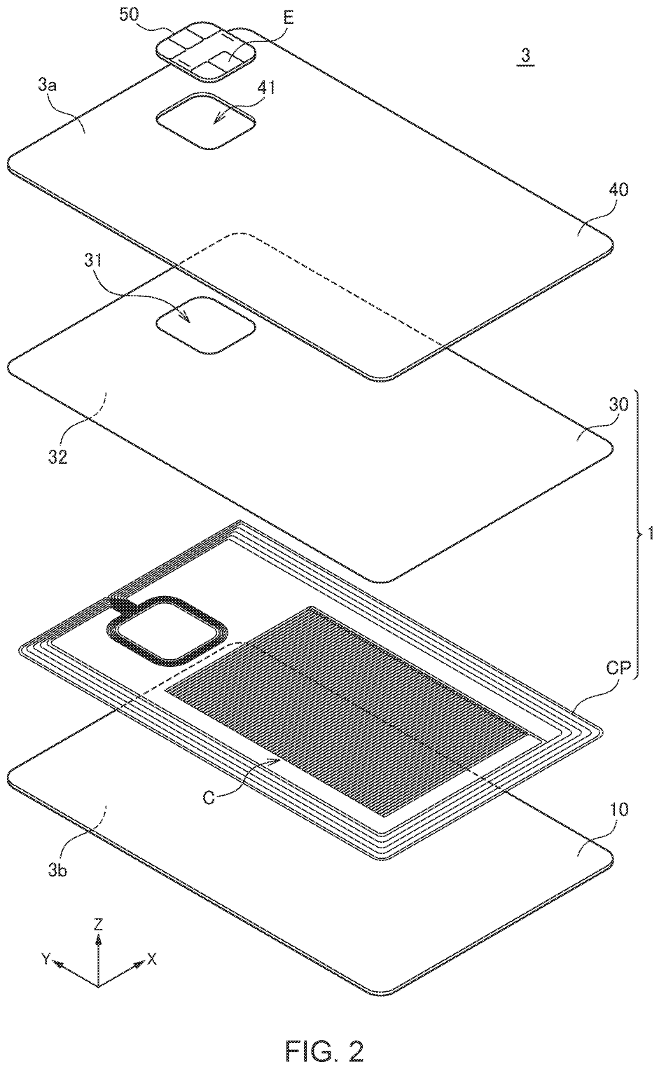

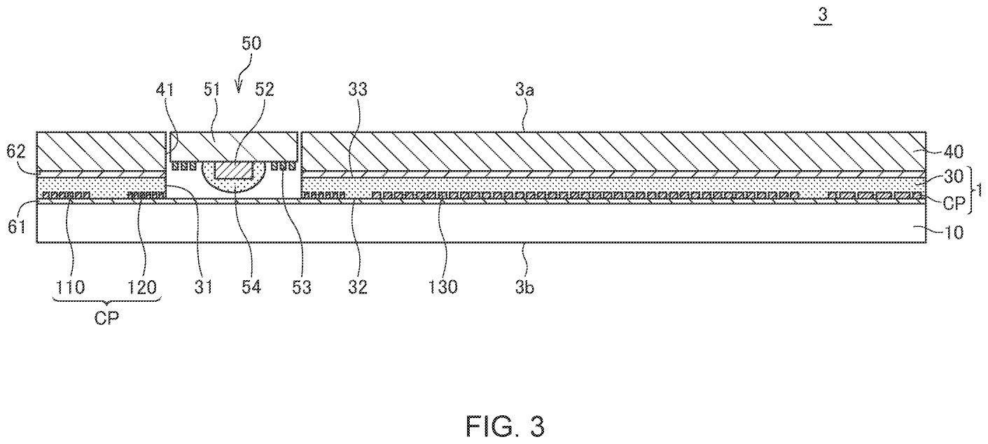

FIGS. 2 and 3 are respectively a schematic exploded perspective view and a schematic cross-sectional view for explaining the structure of the IC card 3 having an antenna device 1 according to a first embodiment of the present disclosure.

The IC card 3 illustrated in FIGS. 2 and 3 has a structure in which a plastic plate 10, a magnetic body 30, and a metal plate 40 are laminated in this order from the back surface 3b side to the upper surface 3a side. The plastic plate 10 is made of a resin material not hindering the passage of magnetic flux. The surface of the plastic plate 10 constitutes the back surface 3b of the IC card 3. The metal plate 40 is made of a metal material such as stainless steel or titanium. The surface of the metal plate 40 constitutes the upper surface 3a of the IC card 3. The metal plate 40 has a through hole 41 in which an IC module 50 is disposed. As described above, the IC card 3 is a card using a metal plate as its main body.

Conductor patterns including a coil pattern CP are disposed between the plastic plate 10 and the magnetic body 30. In other words, the magnetic body 30 is sandwiched between the coil pattern CP and the metal plate 40. A conductive material constituting the conductor patterns may be copper, aluminum, or an alloy thereof, for example.

The antenna device 1 does not have a substrate for supporting the conductor patterns and has a structure in which at least some of the conductor patterns are embedded in a surface 32 of the magnetic body 30. Thus, all the conductor patterns overlap the magnetic body 30 in a plan view (as viewed in the Z-direction or thickness direction). The coil pattern CP does not overlap a through hole 41 of the metal plate 40 in a plan view (as viewed in the Z-direction).

The magnetic body 30 is not a sheet-like member but manufactured by applying a pasty material obtained by mixing magnetic particles and resin to a substrate having conductor patterns thereon, followed by curing of the past material and peeling off of the substrate. Thus, at least some of the conductor patterns are embedded in the magnetic body 30 such that not only the upper surfaces (XY plane) thereof positioned on the opposite side to the bottom surfaces (XY plane) thereof exposed from the magnetic body 30, but also the side surfaces thereof connecting the bottom and upper surfaces are covered with the magnetic body 30. As described above, in the present embodiment, the magnetic body 30 is formed of a pasty material obtained by mixing magnetic particles and resin, and the substrate having conductor patterns thereon is removed, thus eliminating the need to provide the substrate and an adhesive layer, which correspondingly reduces the entire thickness.

The surface 32 of the magnetic body 30 is stuck to the plastic plate 10 through an adhesive layer 61. A back surface 33 of the magnetic body 30 is stuck to the metal plate 40 through an adhesive layer 62. The magnetic body 30 has a through hole 31 at a position overlapping the through hole 41 of the metal plate 40. The antenna device 1 according to the present embodiment is constituted at least by the coil pattern CP and magnetic body 30 embedding the coil pattern CP therein. The through hole 41 of the metal plate 40 and the through hole 31 of the magnetic body 30 have substantially the same size.

The antenna device 1 having such a configuration is manufactured as follows. First, conductor patterns are formed on the substrate of a film-like substrate made of PET (Polyethylene Terephthalate) or the like, and then a pasty material obtained by mixing magnetic particles and resin is applied onto the entire surface of the substrate so as to cover the conductor patterns. Subsequently, the pasty material is cured, followed by peeling-off of the substrate. Finally, punching is performed with a die to form the through hole 31 in the magnetic body 30. Thus, the antenna device 1 according to the present embodiment is completed. The substrate may be peeled off after the punching process.

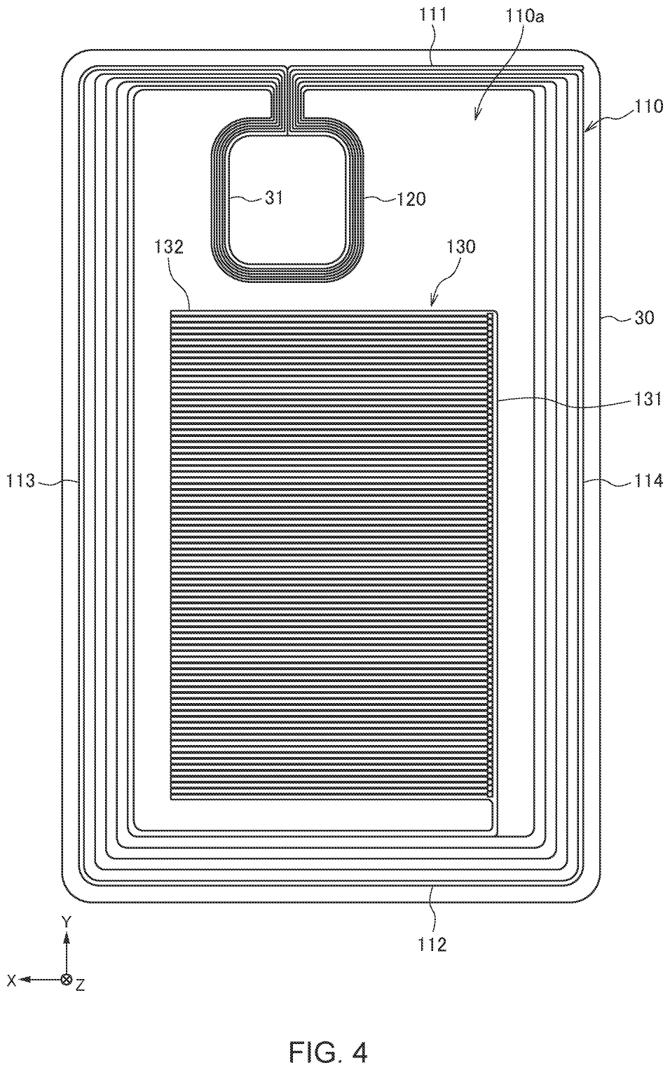

FIG. 4 is a schematic plan view of the conductor patterns including the coil pattern CP.

As illustrated in FIG. 4, the conductor patterns embedded in the surface 32 of the magnetic body 30 include the coil pattern CP and a capacitor pattern 130. The coil pattern CP includes a first winding part 110 and a second winding part 120. The first winding part 110 is a pattern wound in about six turns along the outer edge of the magnetic body 30, and the second winding part 120 branched from the first winding part 110 and the capacitor pattern 130 are disposed inside an opening 110a of the first winding part 110. The second winding part 120 is a pattern wound in about six turns along the periphery of the through hole 31 of the magnetic body 30. The outer peripheral end of the first winding part 110 is opened.

The first winding part 110 includes first and second sections 111 and 112 extending in the X-direction (first direction), a third section 113 extending in the Y-direction (second direction) and connecting one end of the first section 111 and one end of the second section 112, and a fourth section 114 extending in the Y-direction (second direction) and connecting the other end of the first section 111 and the other end of the second section 112. The turns constituting the one end of the first section 111 connected with the third section 113 and the turns constituting the other end of the first section 111 connected with the fourth section 114 are not the same. The second winding part 120 protrudes from the first section 111 of the first winding part 110 toward the through hole 31 of the magnetic body 30 and wound along the periphery of the through hole 31 of the magnetic body 30 in a direction opposite to the winding direction of the first winding part 110. That is, the second winding part 120 is a winding pattern obtained by deforming the turns constituting the first section 111 of the first winding part 110 toward the inside of the opening 110a.

As illustrated in FIG. 4, the turns of the second winding part 120 are inserted in the middle of the respective turns of the first section 111 of the first winding part 110. The turns of the first section 111 of the first winding part 110 are divided at a part between the one end and the other end in the first direction, and the one and the other ends of the divided part are connected through the turns of the second winding part 120.

The pattern width of the first section 111 of the first winding part 110 is smaller than the pattern widths of the second to fourth sections 112 to 114 of the first winding part 110. This can reduce the pattern width of the second winding part 120 protruding from the first section 111, thus making it possible to bring the turns constituting the second winding part 120 closer to the edge of the through hole 31 of the magnetic body 30 while ensuring a sufficient number of turns of the second winding part 120. In addition, the second to fourth sections 112 to 114 each have a sufficient pattern width, so that the first winding part 110 has a reduced resistance value. Furthermore, in the second to fourth sections 112 to 114, the pattern widths of the innermost and outermost turns are smaller than those of the turns positioned therebetween. As portions around the innermost and outermost turns have a high magnetic flux density, the pattern widths of the innermost and outermost turns are thus selectively reduced, whereby it is possible to reduce an eddy current while suppressing an increase in resistance value.

The capacitor pattern 130 is disposed inside the opening 110a of the first winding part 110 and connected to the inner peripheral end of the first winding part 110. The capacitor pattern 130 has a linear pattern 131 extending in the Y-direction and a plurality of linear patterns 132 branched from the linear pattern 131 and extending in parallel to one another in the X-direction. There is no conductor pattern that is opposed to the capacitor pattern 130, and a required capacitance is obtained by a parasitic capacitance generated between adjacent linear patterns 132. The capacitor pattern 130 is a terminated conductor pattern, and thus the coil pattern CP has a structure in which both ends thereof are opened.

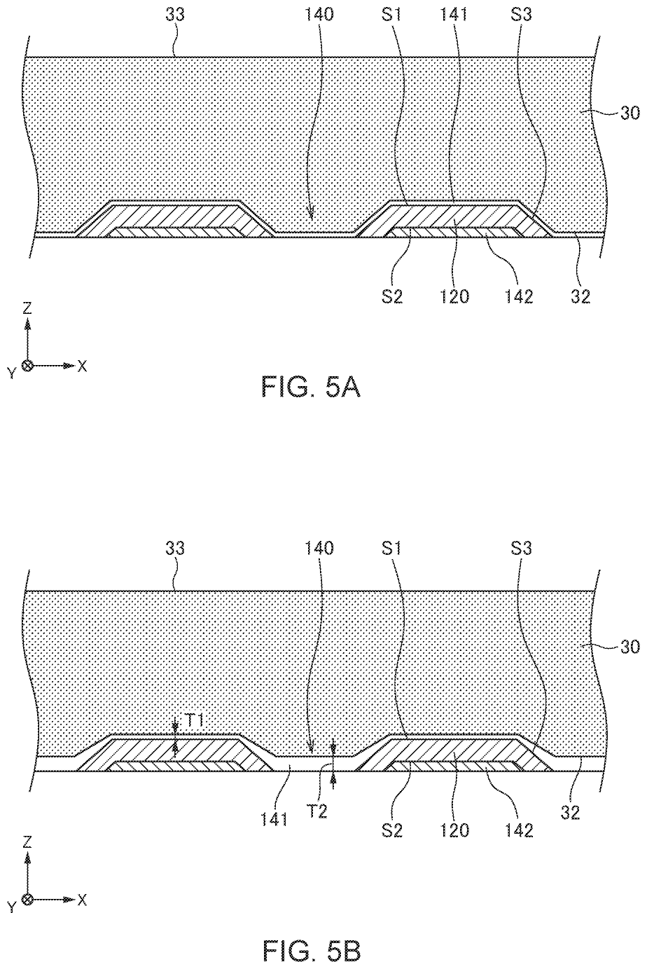

FIG. 5A is a schematic view for explaining the sectional shape of the coil pattern CP embedded in the magnetic body 30. FIG. 5A illustrates a part of the second winding part 120 of the coil pattern CP, and other conductor patterns have the same sectional shape.

As illustrated in FIG. 5A, the second winding part 120 of the coil pattern CP has an upper surface S1 and a bottom surface S2 which are positioned respectively on one end side and the other end side in the thickness direction (Z-direction) and a side surface S3 connecting the upper surface S1 and the bottom surface S2. The upper surface S1 and bottom surface S2 constitute the XY plane. The upper surface S1 and side surface S3 are substantially entirely covered with the magnetic body 30, while the bottom surface S2 is not covered with the magnetic body 30 but exposed from the surface 32 of the magnetic body 30.

The upper and side surfaces S1 and S3 of the coil pattern CP may contact the magnetic body 30; however, when the magnetic body 30 has low insulating performance, the upper and side surfaces S1 and S3 may be covered with an insulating film 141. In this case, the magnetic body 30 covers at least partially the upper and side surfaces S1 and S3. The material of the insulating film 141 may be resin containing adhesive agent or ceramic. The insulating film 141 is provided not only on the surface of the conductor pattern, but also in a space 140 between adjacent turns of the coil pattern CP. Thus, even the magnetic body 30 has low insulating performance, a short-circuit between adjacent turns can be prevented. In the example illustrated in FIG. 5A, the insulating film 141 covers the entire surface 32 of the magnetic body 30, whereby magnetic particles contained in the magnetic body 30 are prevented from falling.

Further, as in a modification illustrated in FIG. 5B, the insulating film 141 may be configured such that a thickness T2 thereof between adjacent turns of the second winding part 120 is larger than a thickness T1 thereof between the second winding part 120 and the magnetic body 30. This can enhance flatness of the surface 32 of the magnetic body 30.

A part of the bottom surface S2 of the coil pattern CP is covered with and protected by a resin layer 142. The resin layer 142 extends in the peripheral direction along the coil pattern CP, and the radial width thereof is smaller than the radial width of the coil pattern CP. Thus, the remaining part of the bottom surface S2 is exposed to both sides of the resin layer 142 in the radial direction. That is, the center portion in the radial direction of the bottom surface S2 of the coil pattern CP is covered with the resin layer 142, while the both side portions thereof in the radial direction is not covered with the resin layer 142. This increases the sectional area of the coil pattern CP, making it possible to reduce a resistance value. The both side portions of the bottom surface S2 of the coil pattern CP that is not covered with the resin layer 142 and the surface of the resin layer 142 form the same plane. The width of the resin layer 142 in the radial direction of the coil pattern CP may be the same as the radial width of the coil pattern CP.

The cross section of the coil pattern CP has such a shape that the radial width becomes smaller from the bottom surface S2 toward the upper surface S1. That is, the side surface S3 does not extend in the Z-direction but has a predetermined inclination with respect to the Z-direction. This allows more magnetic particles to enter between adjacent turns, making it possible to increase a parasitic capacitance generated between the adjacent turns. The parasitic capacitance generated between adjacent turns acts to supplement a capacitance generated from the capacitor pattern 130. By adjusting the capacitance to set the resonance frequency of a resonance circuit constituted by the coil pattern CP and capacitor pattern 130 to 13.56 MHz or a frequency band around 13.56 MHz, NFC (Near Field Communication) is enabled. The side surface S3 may be a curved surface.

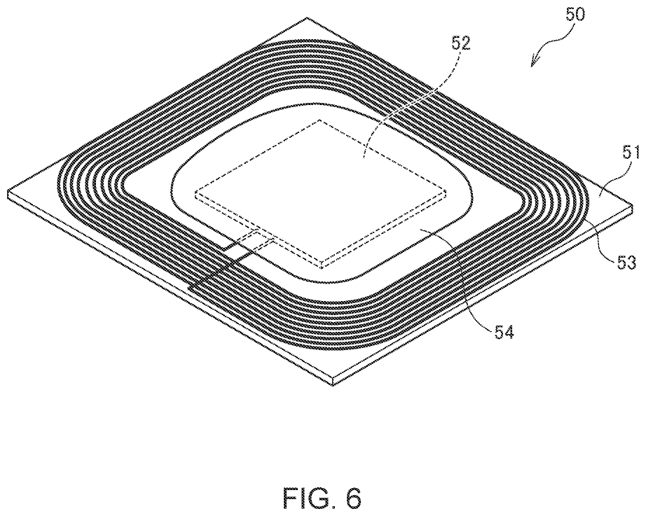

FIG. 6 is a schematic perspective view of the IC module 50 as viewed from the back surface side thereof.

As illustrated in FIG. 6, the IC module 50 includes a module substrate 51, an IC chip 52 mounted on or incorporated in the module substrate 51, and a coupling coil 53. The IC chip 52 is protected by being covered with a dome-shaped protective resin 54. The protective resin 54 is made of an insulating member and may be partially disposed in the through hole 31, as illustrated in FIG. 3. The terminal electrode E illustrated in FIG. 1 is provided on the back surface side of the module substrate 51. The IC module 50 thus configured is accommodated in the through hole 41 formed in the metal plate 40. In a state where the IC module 50 is accommodated in the through hole 41, the coupling coil 53 and the second winding part 120 of the coil pattern CP embedded in the magnetic body 30 are electromagnetically coupled to each other. The second winding part 120 is connected in series to the first winding part 110 as described above, thus allowing the IC module 50 to communicate with external devices through the first winding part 110 and second winding part 120.

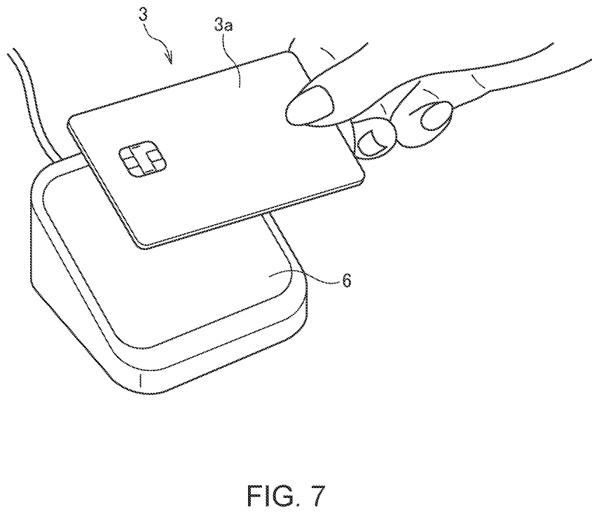

Thus, as illustrated in FIG. 7, when the back surface 3b of the IC card 3 is made to face a card reader 6, communication can be performed between the card reader 6 and the IC chip 52. That is, the card reader 6 is coupled to the coupling coil 53 of the IC module 50 through the first and second winding parts 110 and 120 of the coil pattern CP and can thereby communicate with the IC chip 52.

As described above, in manufacturing the antenna device 1 according to the present embodiment, the magnetic body 30 is applied onto the entire surface of a substrate on which the coil pattern CP is formed, followed by formation of the through hole 31 through a punching process, so that all the conductor patterns overlap the magnetic body 30 in the Z-direction. The magnetic body 30 functions as a magnetic path for increasing inductance of the first winding part 110 of the coil pattern CP, while it can be a factor that inhibits coupling between the second winding part 120 and the coupling coil 53 of the IC module 50. However, in the present embodiment, the second winding part 120 is a winding pattern obtained by deforming the turns constituting the first winding part 110 toward the inside of the opening 110a, so that the second winding part 120 has the same number of turns as the first winding part 110. That is, a sufficient number of turns is ensured for the second winding part 120. In addition, the second winding part 120 is disposed close to the through hole 31 of the magnetic body 30, thus allowing coupling between the second winding part 120 and the coupling coil 53 of the IC module 50 to be maintained.

Further, in the present embodiment, the coil pattern CP is embedded in the surface 32 of the magnetic body 30, and a substrate used for manufacturing the coil pattern CP is peeled off (removed), allowing a reduction in the entire thickness of the antenna device 1.

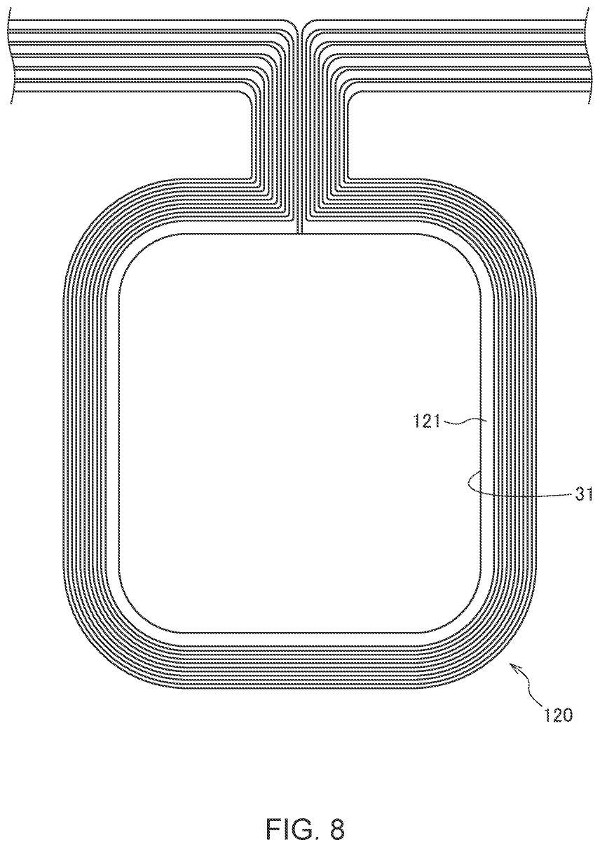

FIG. 8 is a schematic plan view for explaining the pattern shape of the second winding part 120 according to a modification.

In the example illustrated in FIG. 8, the pattern width of an innermost turn 121 of the second winding part 120 is larger than those of the other turns, and the inner peripheral surface of the innermost turn 121 forms the same surface as the inner peripheral surface of the through hole 31 of the magnetic body 30. That is, the position of the inner peripheral edge of the innermost turn 121 of the second winding part 120 coincides with the planar position of the inner peripheral edge of the through hole 31 of the magnetic body 30, and the magnetic body 30 is not present inside the inner peripheral edge of the innermost turn 121.

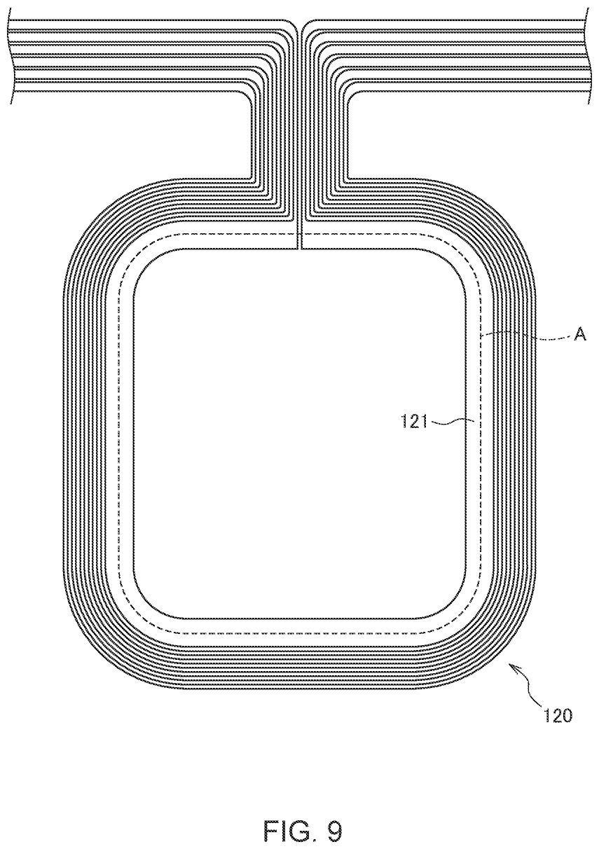

Such a configuration can be obtained by, as illustrated in FIG. 9, selectively increasing the pattern width of the innermost turn 121 of the second winding part 120 so as to make the opening size of the second winding part 120 smaller than the opening size of the through hole 31 and then performing punching at a position (denoted by “A”) overlapping the innermost turn 121 to form the through hole 31. This can reduce the resistance value of the second winding part 120. Further, since the inner peripheral surface of the innermost turn 121 of the second winding part 120 is not covered with the magnetic body 30 but exposed to the through hole 31, coupling between the second winding part 120 and the coupling coil 53 of the IC module 50 can be enhanced.

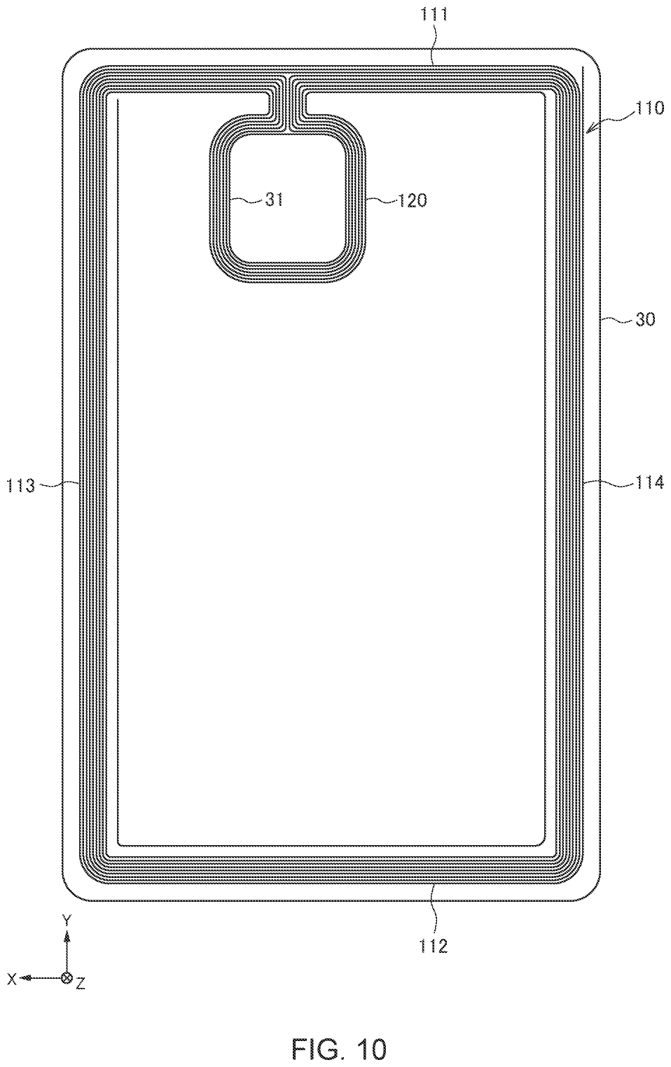

FIG. 10 is a schematic plan view for explaining the pattern shape of the coil pattern CP according to a modification.

The coil pattern CP illustrated in FIG. 10 differs from the coil pattern CP illustrated in FIG. 4 in that the first to fourth sections 111 to 114 constituting the first winding part 110 have substantially the same pattern width. This can further increase the area of the opening 110a of the first winding part 110. Further, in the example illustrated in FIG. 10, the inner peripheral end of the coil pattern CP is not connected with the capacitor pattern 130. That is, the capacitor pattern 130 to be connected to the coil pattern CP need not necessarily be provided.

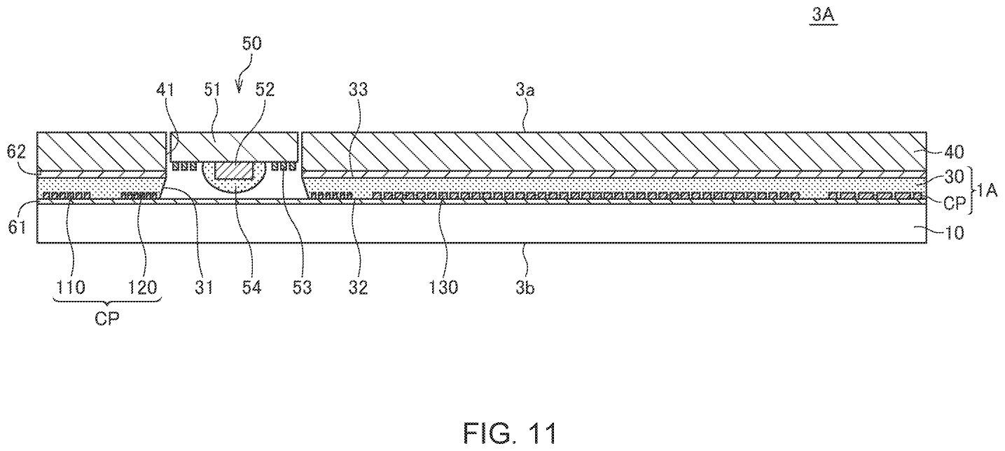

FIG. 11 is a schematic cross-sectional view for explaining the structure of an IC card 3A having an antenna device 1A according to a modification of the present embodiment.

As illustrated in FIG. 11, the antenna device 1A according to the modification differs from the antenna device 1 illustrated in FIG. 3 in that the through hole 31 formed in the magnetic body 30 has a tapered shape. Other basic configurations are the same as those of the antenna device 1 illustrated in FIG. 3, so the same reference numerals are given to the same elements, and overlapping description will be omitted.

The tapered shape as illustrated in FIG. 11 can be obtained by setting, in punching process for forming the through hole 31, the back surface 33 of the magnetic body 30 as a die side and the surface 32 of the magnetic body 30 as a punch side. With this configuration, the opening width of the through hole 31 of the magnetic body 30 decreases with the distance from the surface 32, thereby preventing degradation in antenna characteristics.

While the embodiment of the present disclosure has been described, the present disclosure is not limited to the above embodiment, and various modifications may be made within the scope of the present disclosure, and all such modifications are included in the present disclosure.

The technology according to the present disclosure includes the following configuration examples but not limited thereto.

An antenna device according to one embodiment of the present disclosure includes: a magnetic body having a through hole therein; and a coil pattern having upper and bottom surfaces positioned on one side and the other side in the thickness direction thereof and a side surface connecting the upper and bottom surfaces and being partially embedded in the magnetic body such that the upper and side surfaces are at least partially covered with the magnetic body. The coil pattern includes a first winding part and a second winding part protruding from the first winding part toward the through hole formed in the magnetic body in a plan view and wound in a direction opposite to the winding direction of the first winding part. The second winding part is wound along the periphery of the through hole formed in the magnetic body. With this configuration, the antenna device can communicate not only with devices positioned on the side of the magnetic body at which the coil pattern is embedded, but also with devices positioned on the back surface side of the magnetic body through the through hole formed in the magnetic body.

The above antenna device may further include an insulating film that covers the upper and side surfaces of the coil pattern, and the insulating film may be partially disposed in a space between adjacent turns of the coil pattern. This can prevent short-circuit between adjacent turns of the coil pattern. In this case, the insulating film may be configured such that the thickness thereof between adjacent turns of the second winding part is larger than the thickness thereof between the second winding part and the magnetic body. This can enhance flatness of the magnetic body.

The above antenna device may further include a resin layer that is provided along the bottom surface of the coil pattern, and the width of the resin layer in the radial direction of the coil pattern may be smaller than the radial width of the coil pattern. This protects the bottom surface of the coil pattern.

In the above antenna device, the cross section of the coil pattern may have a shape whose width decreases from the bottom surface toward the upper surface. This increases a capacitance generated between adjacent turns.

In the above antenna device, the pattern width of the innermost turn of the second winding part may be larger than those of the other turns of the second wining part. With this configuration, when an IC module having a coupling coil is disposed at a position overlapping the through hole, power received from the coupling coil can be efficiently used.

In the above antenna device, the inner peripheral surface of the innermost turn of the second winding part may form the same surface as the inner peripheral surface of the through hole of the magnetic body. With this configuration, when an IC module having a coupling coil is disposed at a position overlapping the through hole, coupling between the second winding part and the coupling coil is enhanced.

In the above antenna device, the through hole of the magnetic body may have a shape whose opening width decreases with distance from the surface of the coil pattern on the side at which the coil pattern is embedded. This can prevent degradation in antenna characteristics.

In the above antenna device, the first winding part may include first and second sections linearly extending in a first direction, a third section extending in a second direction perpendicular to the first direction and connecting one end of the first section and one end of the second section, and a fourth section extending in the second direction and connecting the other end of the first section and the other end of the second section. The second winding part may protrude from the first section toward the through hole in a plan view. The pattern width of the coil pattern at the first section may be smaller than the pattern width of the coil pattern at the second to fourth sections. With the above configuration, the pattern width of the second winding part can be reduced.

An IC card according to one embodiment of the present disclosure includes: any of the above antenna devices; a metal plate having a through hole, and an IC module disposed in the through hole of the metal plate. The metal plate and antenna device are laminated such that the through hole of the metal plate and the through hole of the magnetic body overlap each other and that the magnetic body is sandwiched between the coil pattern and the metal plate. This allows the second winding part of the coil pattern and the IC module to be coupled to each other.

What is claimed is:

1. An antenna device comprising:
a magnetic body having a through hole therein; and
a coil pattern having upper and bottom surfaces positioned opposite to each other in a thickness direction thereof and a side surface connecting the upper and bottom surfaces,
wherein the coil pattern is partially embedded in the magnetic body such that the upper and side surfaces of the coil pattern are at least partially covered with the magnetic body,
wherein the coil pattern includes a first winding part and a second winding part protruding from the first winding part toward the through hole formed in the magnetic body in a plan view and wound in a direction opposite to the winding direction of the first winding part, and
wherein the second winding part is wound along a periphery of the through hole formed in the magnetic body.

2. The antenna device as claimed in claim 1, further comprising an insulating film that covers the upper and side surfaces of the coil pattern,
wherein a part of the insulating film is disposed in a space between adjacent turns of the coil pattern.

3. The antenna device as claimed in claim 2, wherein the insulating film is configured such that a thickness thereof between adjacent turns of the second winding part of the coil pattern is larger than a thickness thereof between the second winding part of the coil pattern and the magnetic body.

4. The antenna device as claimed in claim 1, further comprising a resin layer provided along the bottom surface of the coil pattern,
wherein a width of the resin layer in a radial direction is smaller than a radial width of the coil pattern.

5. The antenna device as claimed in claim 1, wherein a cross section of the coil pattern has a shape whose width decreases from the bottom surface toward the upper surface.

6. The antenna device as claimed in claim 1, wherein a pattern width of an innermost turn of the second winding part of the coil pattern is larger than those of other turns of the second wining part.

7. The antenna device as claimed in claim 1, wherein an inner peripheral surface of an innermost turn of the second winding part of the coil pattern forms a same surface as an inner peripheral surface of the through hole of the magnetic body.

8. The antenna device as claimed in claim 1, wherein the through hole of the magnetic body has a shape whose opening width decreases with distance from a surface of the coil pattern on a side at which the coil pattern is embedded.

9. The antenna device as claimed in claim 1,
wherein the first winding part of the coil pattern includes first and second sections linearly extending in a first direction, a third section extending in a second direction perpendicular to the first direction and connecting one end of the first section and one end of the second section, and a fourth section extending in the second direction and connecting another end of the first section and another end of the second section,
wherein the second winding part of the coil pattern protrudes from the first section of the coil pattern toward the through hole in a plan view, and
wherein a pattern width of the coil pattern at the first section is smaller than a pattern width of the coil pattern at the second to fourth sections.

10. An IC card comprising:
An antenna device;
a metal plate having a through hole; and
an IC module disposed in the through hole of the metal plate,
wherein the antenna device comprises:
a magnetic body having a through hole therein; and
a coil pattern having upper and bottom surfaces positioned opposite to each other in a thickness direction thereof and a side surface connecting the upper and bottom surfaces,
wherein the coil pattern is partially embedded in the magnetic body such that the upper and side surfaces of the coil pattern are at least partially covered with the magnetic body,
wherein the coil pattern includes a first winding part and a second winding part protruding from the first winding part toward the through hole formed in the magnetic body in a plan view and wound in a direction opposite to the winding direction of the first winding part,
wherein the second winding part is wound along a periphery of the through hole formed in the magnetic body, and
wherein the metal plate and antenna device are laminated such that the through hole of the metal plate and the through hole of the magnetic body overlap each other and that the magnetic body is sandwiched between the coil pattern and the metal plate.
